(19) United States
(12) Patent Application Publication
(10) Pub. No.: US 2003/0050091 A1
(43) Pub. Date: Mar. 13, 2003

(54) Wireless module structure of notebook-type computer

(76) Inventors: Wen-Sung Tsai, Taipei (TW); Chih-Wen Chiang, Taipei (TW)

Correspondence Address: BACON & THOMAS, PLLC, 625 SLATERS LANE, FOURTH FLOOR, ALEXANDRIA, VA, 22314

(21) Appl. No.: 09/948,541

(22) Filed: Sep. 10, 2001

(51) Int. Cl. H04M 1/00

(52) U.S. Cl. 455/556; 455/66

(57) ABSTRACT

Wireless module structure of notebook-type computer, in which the wireless module is disposed on back side of the display panel of the upper cover of the notebook-type computer. The wireless module via a signal transmission wire is directly connected to an antenna disposed on an edge of the upper cover. The length of the signal transmission wire is shortened and the number of connecting components is reduced. The wireless module will not occupy the interior space of the main frame body, especially the room for the inbuilt modem or LAN module. The noise interference of the internal circuits of the main frame body is reduced. The layout of the interior space in the notebook-type computer can be simplified and the manufacturing cost for the components can be lowered.

### BACKGROUND OF THE INVENTION

The present invention is related to a wireless module structure of notebook-type computer, which is able to simplify the structure of the notebook-type computer and lower manufacturing cost. In addition, the interference of the internal circuits with the wireless signal is reduced.

FIG. 1 shows the wireless module structure of a conventional notebook-type computer. The wireless module 3 is generally installed in the main frame body 1 of the notebook-type computer. (In general, the wireless module 3 is selectively installed at the position of the original modem or LAN module as necessary.) In order to avoid touch of an operator in use, generally the antenna 31 is disposed on the edge of the upper cover 2 of the notebook-type computer. A first transmission wire 32 is disposed between the upper cover 2 and the display panel 21 to connect the antenna 31 with a group of connectors 33 positioned between the hinges of the upper cover 2 and the main frame body 1. The connectors 33 via a second transmission wire 34 are connected to the wireless module 3 in the main frame body 1. The signal received by the antenna 31 can be transmitted to the wireless module 3 and processed. The above arrangement has some shortcomings as follows:

1. The first and second transmission wires 32, 34 between the antenna 31 and the wireless module 3 have relatively long length. The transmission wires 32, 34 go through multiple connectors 33. Accordingly, the antenna 31 is connected to the wireless module 3 via the first transmission wire 32, multiple connectors 33 and the second transmission wire 34. The structure is complicated and the manufacturing and assembling cost for the components is increased.

2. The wireless module 3 is installed in the main frame body 1 equipped with complicated circuits. The wireless module 3 tends to affect the peripheral circuits.

3. The wireless module 3 is generally installed in the main frame body 1 at a position overlapping the position of the inbuilt modem or LAN module. As a result, the modem or LAN module and the wireless module 3 cannot be co-used. This leads to great trouble in design.

4. The wireless module 3 is directly installed in the main frame body. In the case that a purchaser needs another type or the wireless module is damaged and needs to be replaced, it will be very troublesome to disassemble the main frame body for replacing the wireless module.

### SUMMARY OF THE INVENTION

It is therefore a primary object of the present invention to provide a wireless module structure of notebook-type computer, in which the wireless module is directly received in the receiving space between the back side of liquid crystal display panel of the upper cover and the top casing thereof. The wireless module via a signal transmission wire is directly connected to an antenna disposed on an edge of the upper cover. The wireless module will not occupy the interior space of the main frame body, especially the room for the inbuilt modem or LAN module. Therefore, the layout of the interior space in the notebook-type computer is more elastic and simplified. In addition, the wireless module can be easily assembled and disassembled. Therefore, the product can be conveniently and quickly changed into other pattern in accordance with the requirement of a buyer.

It is a further object of the present invention to provide the above wireless module structure of notebook-type computer, in which the length of the signal transmission wire is shortened and the number of connecting components is reduced. Therefore, the manufacturing cost for the components can be lowered.

It is a further object of the present invention to provide the above wireless module structure of notebook-type computer, in which the wireless module is positioned away from the complicated internal circuits of the main frame body so that the noise or electromagnetic wave interference of the internal circuits is reduced. Therefore, a better signal transmission quality is provided.

The present invention can be best understood through the following description and accompanying drawings wherein:

### BRIEF DESCRIPTION OF THE DRAWINGS

FIG. 1 is a perspective view of a conventional wireless module of notebook-type computer;

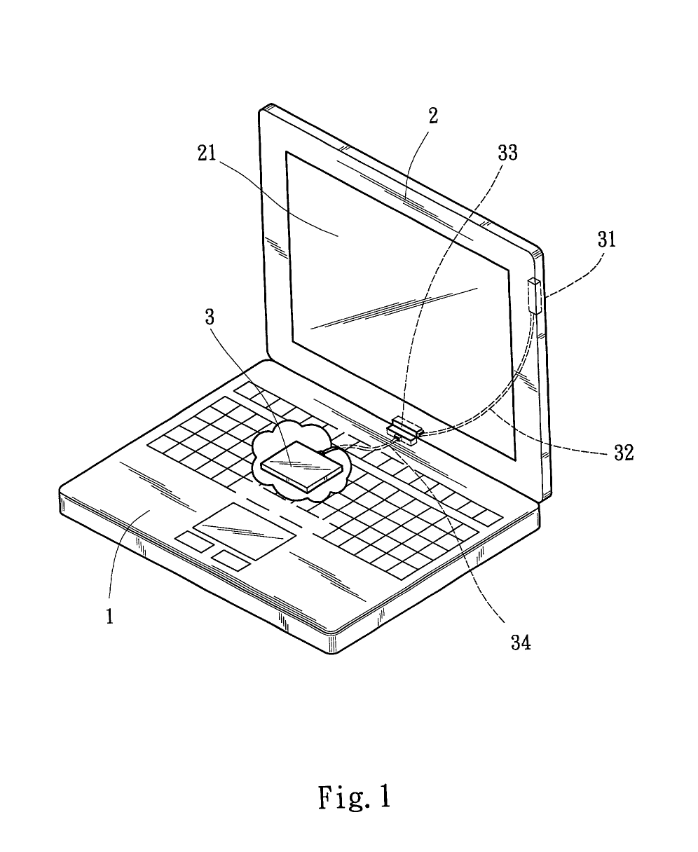

FIG. 2 is a perspective exploded view of the wireless module structure of the present invention; and

FIG. 3 is a perspective assembled view of the wireless module structure of the present invention.

### DETAILED DESCRIPTION OF THE PREFERRED EMBODIMENT

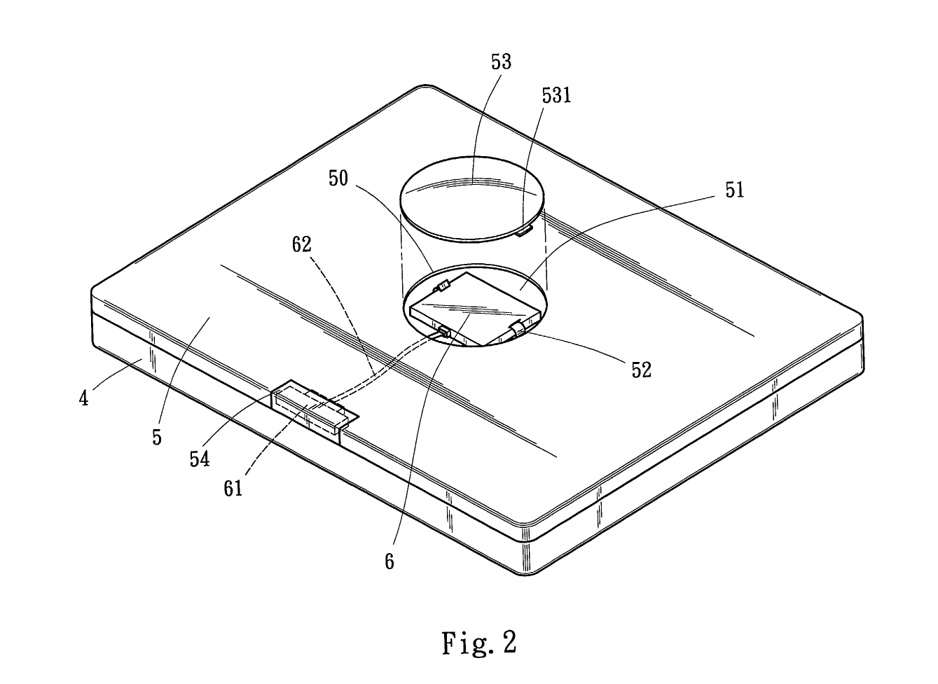

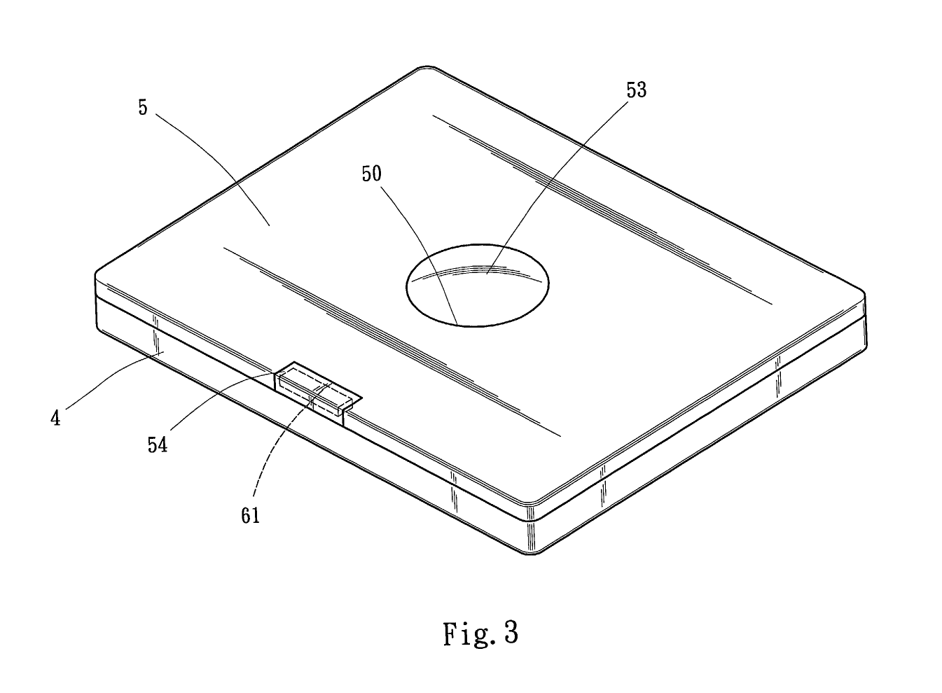

Please refer to FIGS. 2 and 3. The outer face of the upper cover 5 of the notebook-type computer is formed with an opening 50 and a depression 51. Multiple resilient snap plates 52 are disposed in the depression 51. A cover member 53 is disposed in the depression 51. The periphery of the cover member 53 is formed with outward projecting tenons 531. The wireless module 6 is received in the depression 51 of the upper cover 5 with its periphery latched and located by the snap plates 52.

An antenna 61 is mounted on an edge of the upper cover 5. In the case that the upper cover 5 is made of metal material, in order to ensure the signal receiving efficiency of the antenna 61, the casing of the mounting section of the upper cover 5 on which the antenna 61 is mounted is specifically formed with a recess. A shade member 54 made of such material as plastic material which will not interrupt the wireless signal is fitted in the recess. Therefore, the metallic casing of the upper cover will not interrupt the wireless signal. The wireless module 6 is directly via a signal transmission wire 62 connected to the antenna 61 disposed on the edge of the upper cover 5. After the wireless module 6 is completely assembled or disassembled, the cover member 53 is closed to cover the depression 51. By means of the tenons 531, the cover member 53 is engaged with the inner edge of the opening 50 of the upper cover 5 and located.

According to the above structure, the wireless module 6 is directly received in the space between the back side of liquid crystal display panel of the upper cover 5 and the top casing thereof. Therefore, the wireless module 6 will not occupy the interior space of the main frame body 4, especially the room for the inbuilt modem or LAN module. Therefore, the layout in the main frame body 4 can be simplified. Moreover, the distance between the wireless module 6 and the antenna 61 is shortened so that the signal transmission quality is promoted. In addition, the wireless module 6 is not installed in the main frame body 4 so that the noise interference of the internal circuits is reduced and the system is kept stable.

Furthermore, the wireless module 6 is not installed in the main frame body 4 and is covered by an openable cover member 53. Therefore, the wireless module can be easily assembled and disassembled. Therefore, the product can be conveniently and quickly changed into other pattern.

In conclusion, the layout of the interior space in the notebook-type computer can be simplified and the manufacturing cost for the components can be lowered.

The above embodiment is only used to illustrate the present invention, not intended to limit the scope thereof. Many modifications of the above embodiment can be made without departing from the spirit of the present invention.

What is claimed is:

1. Wireless module structure of notebook-type computer, comprising an upper cover of the notebook-type computer, an outer surface of the upper cover being formed with a depression on back side of the display panel, the wireless module being received in the depression and via a signal transmission wire connected to an antenna disposed on an edge of the upper cover.

2. Wireless module structure of notebook-type computer as claimed in claim 1, wherein the depression has an opening covered by an openable cover member.

3. Wireless module structure of notebook-type computer as claimed in claim 2, wherein a periphery of the cover member is formed with outward projecting tenons for engaging with inner periphery of the opening to locate the cover member.

4. Wireless module structure of notebook-type computer as claimed in claim 1, wherein multiple resilient snap plates are disposed in the depression for snapping and locating the wireless module disposed in the depression.

5. Wireless module structure of notebook-type computer as claimed in claim 1, wherein the edge of a mounting section of the upper cover on which the antenna is mounted is formed with a recess sealed by a shade member for covering the antenna, the shade member being made of such material as not to interrupt the wireless signal.

6. Wireless module structure of notebook-type computer as claimed in claim 5, wherein the shade member is made of plastic material.
